(19) United States
(12) Patent Application Publication
(10) Pub. No.: US 2005/0085186 A1
(43) Pub. Date: Apr. 21, 2005

(54) Method and apparatus for measuring adjacent satellite interference

(76) Inventor: William Sandrin, Derwood, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/476,870

(22) PCT Filed: May 8, 2002
(86) PCT No.: PCT/US02/14299

Related U.S. Application Data
(60) Provisional application No. 60/289,389, filed on May 8, 2001.

(51) Int. Cl. H04B 7/185

(52) U.S. Cl. 455/12.1; 455/67.13

(57) ABSTRACT

A system for determining at least one of uplink ASI and downlink ASI in a satellite communication system having at least a first satellite and a second satellite, each having uplink and downlink footprints and being in communication with respective earth stations and having a potential interference. The system comprises a first antenna for receiving downlink signals communicated from said first satellite, a second antenna for receiving downlink signals communicated from said second satellite, power spectrum measurement equipment connected to the second antenna for measuring the second satellite power spectrum, and CSM equipment connected to the first antenna and the power spectrum measurement equipment for generating an adjacent satellite carrier plan.

This application claims the benefit of U.S. Provisional Application Ser. No. 60/289389, filed on May 8, 2002.

### FIELD OF THE INVENTION

The invention relates generally to a method and apparatus for measuring adjacent satellite interference (ASI) using communications system monitoring equipment, for both up-link and down-link interference. ASI is the interference caused to a victim satellite and one or more of the earth stations with which it is in communication by transmissions from an interfering satellite or the earth stations with which it communicates. Typically, ASI is caused by earth station antenna sidelobes or as a result of antenna mis-pointing.

The characterization of adjacent satellite interference (ASI) is a function that is not normally performed by communications system monitoring (CSM) systems implemented in commercial communications satellite networks. However, due to decreased satellite spacing along the geostationary arc, which increases the severity of ASI, it has now become appropriate that the transmissions of adjacent satellites should be monitored, in order to characterize ASI. Such monitoring would permit coordination agreements to be policed, and would allow carrier frequency plans to be optimized to maximize transponder capacity in the presence of ASI.

FIG. 1A illustrates a typical satellite system, comprising plural geostationary satellites 1, 2, 3 4, which include two satellites 3, 4 with beams having respective footprints 6 and 7 (spacecraft antenna coverage areas) that overlap on the surface of the earth 8. An earth station 5 that is located within the two beam footprints 6, 7 is designed to transmit to satellite 4, but its signal also is transmitted to adjacent satellite 3. Uplink ASI occurs when the earth stations like station 5 are transmitting to an adjacent satellite 4 (in the same frequency band) and cause interference to a victim satellite 3, either via the earth station's antenna sidelobes, or via the main lobe due to antenna mis-pointing. Similarly, earth stations transmitting to satellites 1 and 2 may also cause uplink ASI.

FIG. 1B also illustrates a typical satellite system, comprising plural geostationary satellites 11, 12, 13 14, which include two satellites 13, 14 with beams having respective footprints 16 and 17 that overlap on the surface of the earth 8. An earth station 15 that is located within the two beam footprints 16, 17 is designed to receive from satellite 13, but it also receives a signal transmitted by adjacent satellite 14. Downlink ASI occurs when earth stations like station 15 that receive transmissions from the victim satellite 13 also receive interference from one or more adjacent satellites 14 (and possibly 11 and 12), either via the earth station's antenna sidelobes, or as a result of earth station antenna mis-pointing. In uplink ASI, it is the earth station transmissions of the interfering satellite's network that produce the interference, while for downlink ASI, it is the earth station receiving systems of the victim satellite's network that contribute to the interference. In both uplink and downlink ASI, ASI can be produced by uplink and downlink emissions that exceed authorized levels, in addition to the earth station imperfections noted above. In both uplink and downlink ASL it is a combination of closely spaced satellites and the use of small earth station antennas that increases the severity of ASI.

Currently, CSM systems include a capability to monitor (modulation type, FEC coding, scrambling patterns, bit error rate (BER), symbol rate estimation, etc.) but do not include the use of equipment for power spectrum measurement and analysis of adjacent satellites. In short, the conventional CSM systems do not provide a capability to monitor ASI, notwithstanding the improved processing capability that new generation CSM systems offer. Accordingly, it is an object of the present invention to provide a method and apparatus for CSM systems, that permit existing systems to be enhanced at a modest cost to include ASI characterization

### SUMMARY OF THE INVENTION

The invention involves a method and apparatus for the provision of a CSM enhancement to include ASI characterization.

The invention more particularly involves a method of characterizing downlink ASI in a communications satellite system having at least a first satellite and at least a second adjacent satellite, each satellite being in communication with a respective earth station via downlink beams that provide overlapping downlink beam footprints. The downlink ASI determination method comprises:
a) capturing the power spectrum of the second adjacent satellite; b) dividing the downlink beam of the second adjacent satellite into transponder segments; c) performing spectrum analysis on each said transponder segment; and d) analyzing the measured power spectrum of the second adjacent satellite to convert measured transponder spectra to estimates of carrier frequency plans.

The invention further comprises a method of characterizing uplink ASI in a communications satellite system having at least a first satellite and a second adjacent satellite, each satellite being in communication with respective earth stations via downlink beams that provide downlink beam footprints and uplink beams that have uplink beam footprints. The method comprises a) using the downlink spectrum of the interfering satellite; and b) processing the downlink in accordance with the above method.

The invention also is directed to a system for determining at least one of uplink ASI and downlink ASI in a satellite communication system having at least a first satellite and a second satellite, each having uplink and downlink footprints and being in communication with respective earth stations and having a potential interference. The system comprises a first antenna for receiving downlink signals communicated from said first satellite, a second antenna for receiving downlink signals communicated from said second satellite, power spectrum measurement equipment connected to the second antenna for measuring the second satellite power spectrum, and CSM equipment connected to the first antenna and the power spectrum measurement equipment for generating an adjacent satellite carrier plan.

### BRIEF DESCRIPTION OF THE DRAWINGS

FIG. 1A is a schematic illustration of a satellite system in which Uplink ASI occurs.

FIG. 1B is a schematic illustration of a satellite system in which Uplink ASI occurs.

FIG. 2 is a schematic illustration of a satellite system having a CSM capability that includes ASI detection.

FIG. 3A is a flow chart that identifies a process for determining downlink ASI.

FIG. 3B is a flow chart that identifies a process for determining uplink ASI.

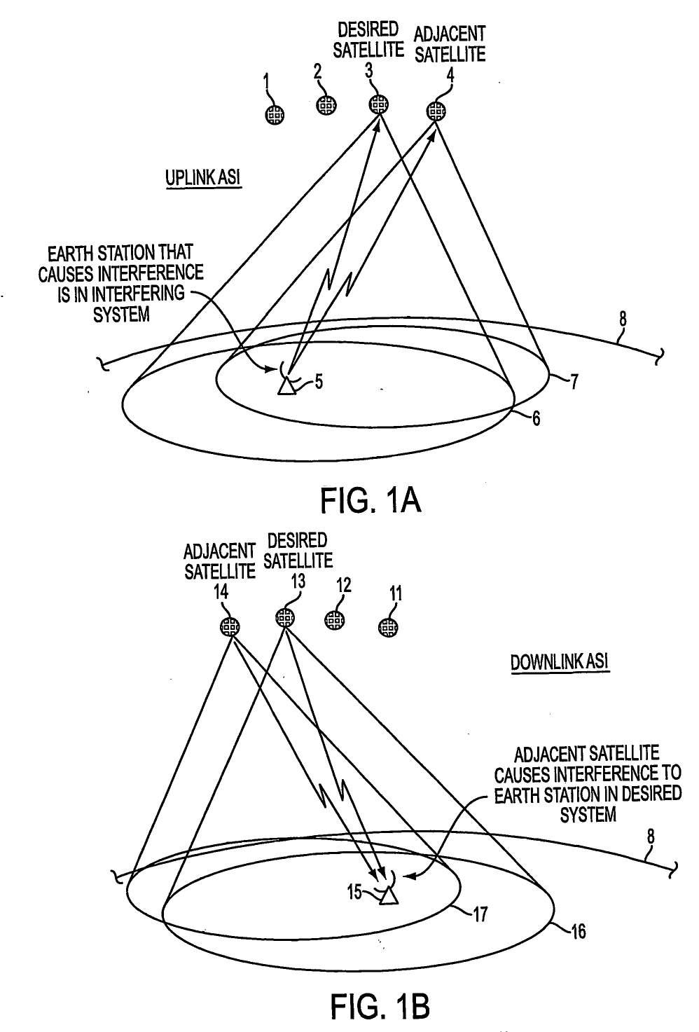

### DESCRIPTION OF THE PREFERRED EMBODIMENTS

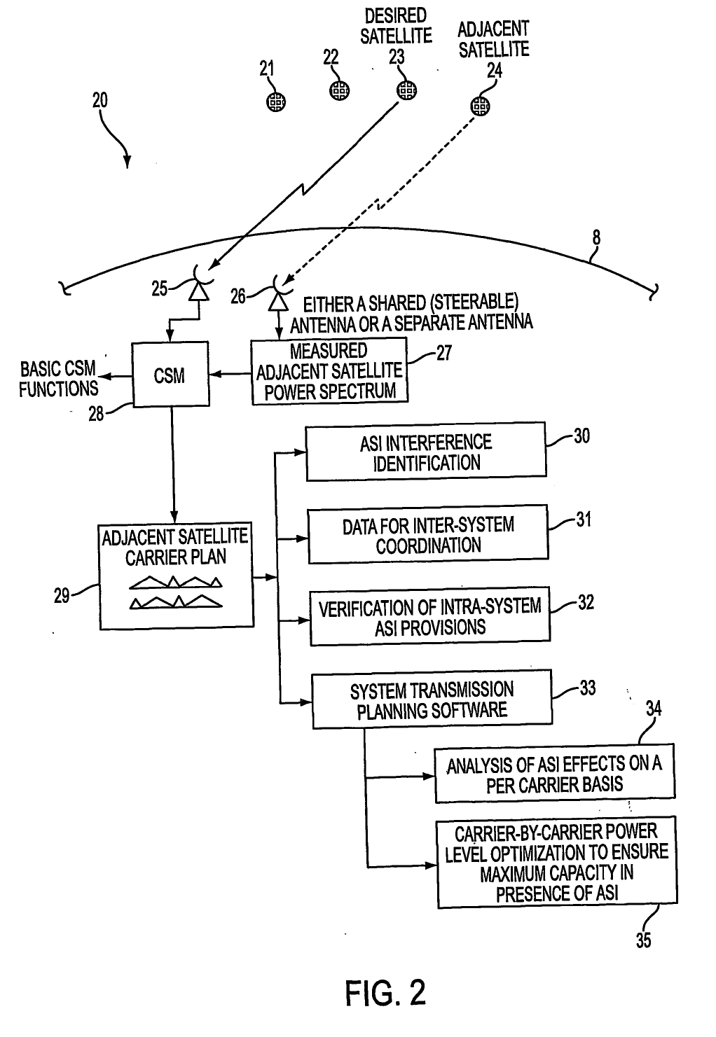

FIG. 2 illustrates the ASI-related features of a satellite system 20 having a plurality of satellites 21, 22, 23, 24 in geostationary orbit, including a satellite that is desired for communication 23 and an adjacent interfering satellite 24. The desired satellite 23 is in communication with an earth station 25 having CSM equipment 28 that can provide conventional CSM functions. Those conventional functions are supplemented by equipment That can determine an adjacent satellite carrier plan. Specifically, a second antenna 26, which may be a shared and steerable antenna that serves several satellites, or a separate dedicated antenna, is provided with equipment that can measure the adjacent satellite 24 power spectrum. That power spectrum output is provided to the CSM 28, which also has the capability 29 to identify the adjacent satellite carrier plan. It also has the capability to characterize ASI for several purposes, including identification of ASI interference 30, provide data for inter-system coordination 31, verify intra-system ASI provisions 32 and utilize system transmission planning software 33 for a variety of purposes. Most importantly, the software can be used to provide an analysis of ASI effects on a per carrier basis 34 and provide carrier by carrier power level optimization 35 in order to ensure maximum capacity in the presence of ASI.

The CSM equipment 28 also must have an adequate processing capability, provided by a conventional processor (not shown) with appropriate software modules.

Finally, there must be a means for conveying adjacent satellite spectral measurements to the location where ASI processing is performed. Depending on the network architecture employed by the basic CSM system, and the extent to which the required processing functions are centralized, additional provisions may be incorporated to convey ASI power spectrum measurements to the locations where ASI information is further processed and used. While the design of the processing and distribution architecture involves tradeoffs between the extent of local processing that is performed, and the amount of data required to be transported, these considerations would not be major issues for a CSM enhancement, particularly if ASI power spectrum measurements are made infrequently.

The antenna 26 that is used to measure emissions from adjacent satellites not only should be able to be pointed along the geostationary arc, but should also be capable of receiving both linear and circular polarizations of each sense, and over bands that may extend beyond the victim satellite's downlink band. If downlink ASI were only of interest, then only the polarization sense(s) and bandwidth of the victim satellite's downlinks need be measured. However if uplink ASI characterization is required, other polarizations and other receive bands may be required to obtain the required replicas of the interfering satellite's uplink spectrum. This requirement is due to the fact that the interfering satellite may use the same uplink bands as the victim satellite, but different downlink bands.

Turning next to the application of the system of FIG. 2 to the solution of practical problems, is should be noted first that there are differences in uplink and downlink ASI, as further detailed subsequently. However, since the implementation to characterize downlink ASI is somewhat simpler than for uplink ASI, downlink ASI is described first.

In downlink ASI, the footprints of both the victim and the interfering satellite overlap in the geographical areas that experience ASI. Also, the downlink spectrum used by affected transponders of the victim satellite overlaps that of the interfering satellite. The objective of downlink ASI characterization is to obtain a description of the interfering satellite's downlink carrier plan in the transponders of the interfering satellite that overlap both the coverage area and frequency band of the victim satellite.

Downlink ASI characterization can be used to assist in identifying the source of interference to the victim satellite 23, in the inter-system coordination process with the operator of the adjacent satellite 24, and to verify that the adjacent satellite's frequency plan matches detailed ASI database information (for cases where the adjacent satellite 24 has the same operator as the victim satellite 23). As indicated in function 34 of FIG. 2, an important use of the adjacent satellite's carrier frequency plan is to incorporate it into the transmission analysis and planning functions of computing the effects of downlink ASI on a carrier-by-carrier basis. A further function, as indicated in function 35 of FIG. 2 is optimizing the carrier frequency plan of the victim satellite to ensure maximum throughput in the presence of ASI. This latter application is useful in cases where either by agreement, or by violation of coordination agreements, ASI is significant enough to require that transmission planning be performed on a carrier-by-carrier basis, rather than for entire bandwidth segments.

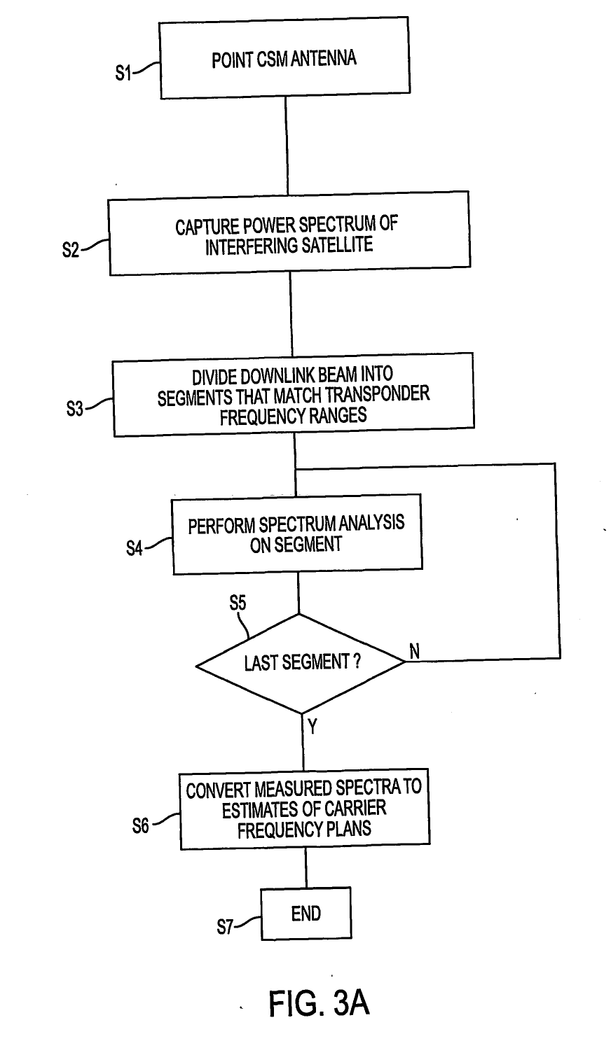

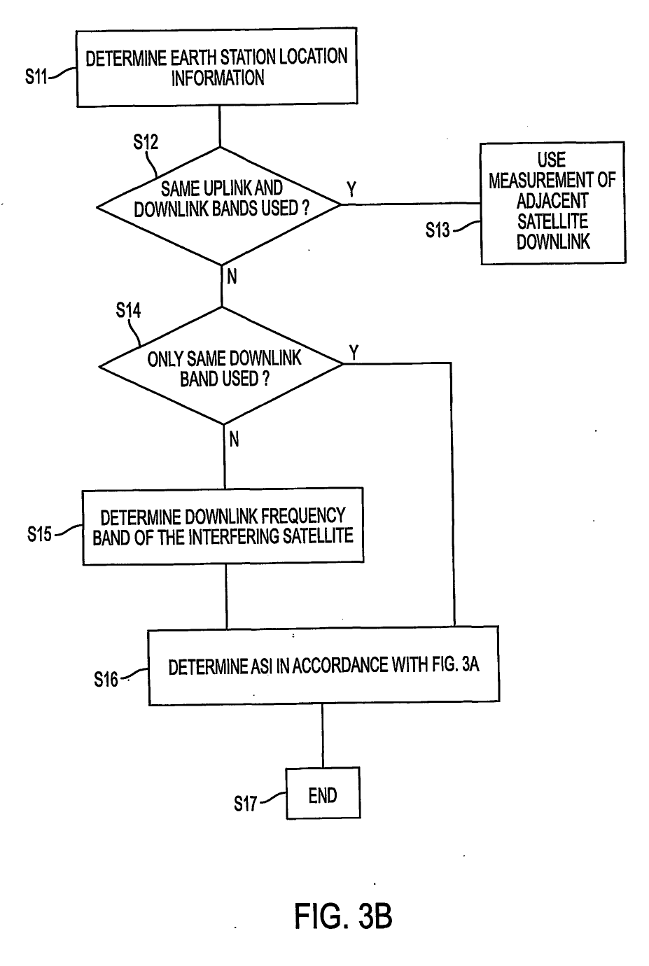

The procedure to characterize downlink ASI is illustrated in the flowchart of FIG. 3A. A first step S1 is to point the CSM antenna 26 (or equivalently, connect to another dedicated antenna whose output can be processed by the CSM 28) towards the adjacent satellite. A second step S2 is to “capture” the power spectrum of the adjacent satellite 24 via the spectrum measurement equipment 27. A third and fourth step S3 and S4 involve the performance of analysis functions in the CSM. For this purpose, spectrum analysis should be done in segments that match the transponder frequency ranges of the victim satellite 23. Accordingly, in step S3, the downlink beam is divided into segments and in step S4 the spectrum analysis is performed on the segment. This measurement must be repeated for all segments until all segments are analyzed. Thus, in step S5, a determination is made as to whether the last segment has been analyzed, and if not, the process loops back to step S4. If it is the last segment, then every transponder segment transmitted by the downlink beam of the interfering satellite 24, which was measured in steps S1 and S2, that causes ASI to one or more downlink beams of the victim satellite 23 has been tested. To characterize downlink ASI on a system wide basis, the process illustrated by FIG. 3A is repeated for each downlink beam of the desired satellite 23, and for each of the adjacent satellites (21, 22, and 24). Note that to characterize downlink ASI for different downlink beams of the desired satellite 23, different measurement locations are required for each of the downlink beams since they cover different geographical regions (except for the case of polarization reuse beams, where in some cases, one measurement site may be able to be used for two beams).

The measured power spectrum of the adjacent satellite 24 is analyzed in step S6 with software that converts measured transponder spectra to estimates of carrier frequency plans 29. Then, the program ends at step S7.

Although for the purposes of ASI interference computation, only the spectral parameters of power, center frequency and spectral shape are required, other parameters such as modulation type, the use of FEC coding, scrambling patterns, etc., that may be outputs of the basic CSM spectral analysis software, also may be used in documenting and coordinating ASI.

Although the way in which information on uplink ASI is used is similar to the way information on downlink ASI is used, the uplink ASI generation mechanism is different from downlink ASI, as earlier noted. In uplink ASI, it is earth stations transmitting to an adjacent satellite 24 that are the source of interference. Assuming that the adjacent satellites 24 are of the conventional bent-pipe type (i.e., that the adjacent satellites do not incorporate on-board processing) the way to characterize uplink ASI is to monitor the downlink of the transponder, which has the carriers that generate uplink ASI, in the adjacent satellite 24. Since it is often the case in commercial satellites that the transponder uplink beam coverages do not overlap the downlink beam coverages, the earth stations that measure the spectrum of the adjacent satellite's transponder, whose carriers are the source of uplink ASI, often must be located far from the uplink coverage area where the uplink ASI is produced.

Thus, while to characterize downlink ASI, little information is required about the adjacent satellite except for its location and downlink footprint (i.e., all other information relevant to downlink ASI can be measured) more information about the interfering satellite is required to characterize uplink ASI. Specifically, both the uplink and downlink beam footprints, the uplink and downlink frequency bands, and the connectivity between the uplink and the transponders of the interfering satellite must be known, so that the locations of the monitoring earth stations can be determined. Thus, in a flowchart in FIG. 3B representing the uplink ASI characterization process, the first step S11 is to determine station location information

In step S12, it is then determined if the adjacent satellite 24 uses the same uplink and downlink frequency bands as the victim satellite 23. If so, then every power spectrum measurement of an adjacent satellite's downlink spectrum (on a transponder-by-transponder basis) will represent both an uplink ASI and a downlink ASI spectrum, and such measurement would be used in step S13.

However, this is not the case if either the uplink or the downlink of the adjacent satellite 24 operates in frequency bands that are different from the victim satellite 23. A determination is made in step S14 of whether the downlink frequency band is the same. For those cases where the uplink of the interfering satellite 24 shares the same frequency band, but where the downlink of the interfering satellite 24 uses a different band (such as, for example, in the case of a cross-strapped transponder) the downlink of the interfering satellite 24 must be received in order to characterize uplink ASI, even though the downlink is in a band that is different from the downlink bands used by the victim satellite 23.

To characterize uplink ASI on a system-wide basis, the process illustrated by FIG. 3B is repeated for each uplink beam of the desired satellite, and for each adjacent satellite.

Once the uplink ASI power spectrum is measured, its characterization and its use are essentially the same as previously described for downlink ASI. That is, information on uplink ASI can be used to assist in identifying the source of interference, as in function 30. It also can assist is coordinating ASI problems with the operator of the adjacent satellite, as in function 31. A further function 32 is to verify that the adjacent satellite's carrier plan conforms to ASI database information in the case where the adjacent satellite is under control of the same operator. Also, uplink ASI can be used with software 33 to compute the effects of ASI on a carrier-by-carrier basis, as in function 34 and optimize capacity in transponders subject to significant levels of ASI, as in function 35. A transmission planning and analysis program 33 would be implemented in a manner known in the art.

The software required for ASI characterization is in two basic categories. First, there is the software required to convert a measured power spectrum into an estimated ASI carrier frequency plan. Second, there is the software that uses the ASI characterization results. It is only the former category that requires processing by the basic CSM equipment, and this processing requirement should be modest since the computations need not be made in real time, and, as noted above, ASI power spectrum measurements should only be required relatively infrequently.

The software required for the purposes of using the ASI characterization results is part of the system operations, planning, and inter-system coordination functions. Hence, any hardware associated with these software functions would not be part of the basic CSM system.

Returning to the first category of software required for ASI characterization, namely that required to convert the measured adjacent satellite's power spectrum into an estimate of the adjacent satellite's carrier frequency plan (over the portion of bandwidth of interest), there are two subcategories. A first subcategory is software that performs this function for the transponders of the desired satellite 23, as part of a basic CSM system. The requirements for this software are not discussed herein as they are known.

However, the second subcategory involves software that defines what ASI measurements are required to be made. This software would use information on adjacent satellites 24 to define the direction, frequency bands, and polarization that are required for ASI measurements. The complexity of the software required for this subcategory is minimal, and would be easily acquired by one skilled in the art, once the requirement is known.

If only downlink ASI were being characterized, an alternative “search mode” procedure could be used to search for satellites along the geostationary arc having emissions in the same band and polarization as the downlink of the desired satellite. Assuming that the footprints of the adjacent satellites overlap with the desired satellite, a procedure for downlink characterization would not require the subcategory of measurement control software identified above.

Turning now to the second category of software, it includes software that makes use of the estimated adjacent satellite carrier plans. Applications in this category include:
a) Software that assists users in identifying interference measured by the CSM for the desired satellite as having ASI, and if so, whether it is uplink or downlink ASI.
b) Software that generates adjacent satellite carrier plans in a format useful for intersystem coordination.
c) Software that compares a measured adjacent satellite carrier plan against ASI information stored in a database. (Useful for system operators that have multiple adjacent satellites.)
d) Transmission planning and analysis software that computes the effects of ASI on the performance of carriers, and optimizes carrier plans to maximize capacity in the presence of ASI.

An example of the last category of software would be the well known STRIP7 and COMPLAN programs developed by LMGT (formerly COMSAT Laboratories). The STRIP7 program is specialized to Intelsat's requirements, and has a provision for computing impairments caused by intra-system ASI from its own satellites. The COMPLAN program, which is applicable to non-Intelsat satellites, requires a straightforward modification to handle ASI impairments.

These two programs (or software with similar capabilities) perform two important functions for an FDMA (frequency division multiple access) system. The first function is that they analyze the performance of every carrier in a satellite transponder, taking into account impairments due to thermal noise, intermodulation noise, intra-satellite co-channel interference, adjacent carrier interference, and uplink and downlink rain impairments. To these impairments, ASI must be added in the software envisioned for this application (which is already implemented in STRIP7, as noted above). Since the amount of ASI is dependent on both the characteristics of the uplink earth stations of the interfering satellite, and the downlink earth stations of the victim satellite, the ability to analyze transmission performance on an individual carrier basis is important, since such performance estimates cannot be accurately made solely from the carrier plan of the adjacent satellite.

The second function of these two transmission analysis programs is that given the carrier frequency assignments of a frequency plan, the uplink carrier powers are optimized so that the power-limited capacity of the transponder is maximized. This is done by computing the effects of the impairments noted above on each individual carrier and providing each carrier with the amount of power it requires to achieve specified performance, while maintaining an optimum transponder operating point (i.e., while maintaining an optimum balance between downlink thermal noise, intermodulation noise, and interference.)

The utility of applying ASI to transmission planning and analysis software is that for situations where ASI is significant, and cannot be eliminated by either intra- or inter-system coordination, the effects of ASI can be quantified on an individual carrier basis, and the transmission plan of a satellite affected by ASI can be optimized to minimize ASI effects. (This can result in significant savings in satellite power, since without such quantitative tools, unnecessarily large link margins may be used to protect against ASI.)

As described, adding a capability to a CSM system to characterize ASI provides a significant benefit to a satellite system operator. Such addition would require only modest resources in addition to those required by the basic CSM system. The features of such a system are readily implemented on the basis of even the high level description that has been provided. Specifically, they include the incorporation into a CSM of a power spectrum measurement and analysis capability that results in a detailed description of frequency plans used by adjacent satellites. They also consist of the use of the measured adjacent satellite frequency plans, including:
i) Using adjacent satellite frequency plan information, as determined by an enhanced CSM, to identify specific interferers that have been measured in the victim satellite's transponders by the CSM as being due to ASI, and if so, whether it is uplink or downlink ASI.
ii) Using adjacent satellite frequency plan information, as determined by an enhanced CSM, to facilitate inter-system coordination.
iii) Using adjacent satellite frequency plan information, as determined by an enhanced CSM, to verify intra-system ASI coordination provisions.
iv) Using adjacent satellite frequency plan information, as determined by an enhanced CSM, to analyze the effect of ASI on carrier-by-carrier basis for a FDMA transponder.
v) Using adjacent satellite frequency plan information, as determined by an enhanced CSM, to optimize the uplink powers of individual carriers for a EDMA transponder where ASI is significant, so as to maximize the transponder's power-limited capacity.

It should be noted that this improvement over the conventional CSM system will minimize the amount of equipment and software required to measure and characterize ASI, as compared to the standalone systems used conventionally, notwithstanding the enhanced automation that is used.

While the present invention has been explained in accordance with certain preferred or exemplary embodiments, it is not limited thereto, and the scope of the invention is to be defined by the appended claims, as interpreted in accordance with applicable law.

1. A method of characterizing downlink ASI in a communications satellite system having at least a first satellite and at least a second adjacent satellite, each said satellite being in communication with a respective earth station via downlink beams that provide overlapping downlink beam footprints, said method comprising:
a) capturing the power spectrum of the second adjacent satellite;
b) dividing the downlink beam of the second adjacent satellite into transponder segments;
c) performing spectrum analysis on each said transponder segment;
d) analyzing the measured power spectrum of the second adjacent satellite to convert measured transponder spectra to estimates of carrier frequency plans.

2. The method of characterizing downlink ASI as recited in claim 1, further comprising, determining downlink ASI on a system-wide basis by repeating the process for each downlink beam of the first satellite, and for each of plural adjacent satellites.

3. The method characterizing downlink ASI as recited in of claim 1 further comprising using different measurement locations for each of different downlink beams that cover different geographical regions.

4. The method of characterizing downlink ASI as recited in claim 1 further comprising pointing a CSM antenna towards the adjacent satellite.

5. The method of characterizing downlink ASI as recited in claim 1 further comprising using spectral parameters of power, center frequency and spectral shape, and optionally at least one of modulation type, FEC coding and scrambling patterns.

6. A method of characterizing uplink ASI in a communications satellite system having at least a first satellite and a second adjacent satellite, each said satellite being in communication with respective earth stations via downlink beams that provide downlink beam footprints and uplink beams that have uplink beam footprints, said method comprising:
a) using the downlink spectrum of the interfering satellite; and
b) processing the downlink in accordance with the method of
1) capturing the power spectrum of the second adjacent satellite via spectrum measurement equipment;
2) dividing the downlink beam of the second adjacent satellite into segments;
3) performing spectrum analysis on each said segment; and
4) analyzing the measured power spectrum of the second adjacent satellite to convert measured transponder spectra to estimates of carrier frequency plans.

7. The method of characterizing uplink ASI as claimed in claim 6, further comprising:
if the second adjacent satellite uses the same uplink and downlink frequency bands as the first satellite, then using only the power spectrum measurement of the second adjacent satellite's downlink spectrum to represent an uplink ASI.

8. The method of characterizing uplink ASI as claimed in claim 6, further comprising:
if either the uplink or the downlink of the second adjacent satellite operates in frequency bands that are different from the first satellite, determining whether the downlink frequency band is the same, and
if the uplink of the second adjacent satellite shares the same frequency band with the first satellite, but where the downlink of the second adjacent satellite uses a different band, receiving the downlink of the second adjacent satellite and characterizing uplink ASI.

9. The method of characterizing uplink ASI as claimed in claim 6, further comprising repeating the characterization of uplink ASI on a system-wide basis, by repeating the process for each uplink beam of the first satellite, and for each adjacent satellite.

10. A method of characterizing uplink ASI as recited in claim 6 further comprising using the derived information in identifying the source of interference.

11. A system for determining at least one of uplink ASI and downlink ASI in a satellite communication system having at least a first satellite and a second satellite, each having uplink and downlink footprints and being in communication with respective earth stations and having a potential interference, comprising:
a first antenna for receiving downlink signals communicated from said first satellite;
a second antenna for receiving downlink signals communicated from said second satellite;
power spectrum measurement equipment connected to said second antenna for measuring the second satellite power spectrum; and
CSM equipment connected to said first antenna and said power spectrum measurement equipment for generating an adjacent satellite carrier plan.

12. The system as set forth in claim 11 wherein said second antenna is a steerable antenna.

13. The system as set forth in claim 11 further comprising at least one of:
a) means for providing ASI interference identification;
b) means for providing data for inter-system coordination;
c) means for providing verification of intra-system ASI provisions; and
d) means for system transmission planning.

14. The system as set forth in claim 13, wherein said means for system transmission planning comprises:
means for analysis of ASI effects on a per carrier basis; and
means for carrier by carrier power level optimization.

15. The system as set forth in claim 11, further comprising means for determining whether each of the uplink and downlink frequency bands for the first and second satellites are the same and, if the same, using the power spectrum of the downlink to represent uplink ASI.
